(19) United States
(12) Patent Application Publication
(10) Pub. No.: US 2023/0269068 A1
(43) Pub. Date: Aug. 24, 2023

(54) CONFIDENTIAL INFORMATION PROCESSING SYSTEM AND CONFIDENTIAL INFORMATION PROCESSING METHOD

(71) Applicant: Mitsubishi Electric Corporation, Tokyo (JP)

(72) Inventor: Ryo HIROMASA, Tokyo (JP)

(73) Assignee: Mitsubishi Electric Corporation, Tokyo (JP)

(21) Appl. No.: 18/142,405

(22) Filed: May 2, 2023

Related U.S. Application Data
(63) Continuation of application No. PCT/JP2020/048498, filed on Dec. 24, 2020.

(51) Int. Cl. H04L 9/00; G06N 5/04; H04L 9/08

(52) U.S. Cl. CPC H04L 9/008; G06N 5/04; H04L 9/088

(57) ABSTRACT

A homomorphic inference device (500) divides a model ciphertext into a ciphertext for inference and a ciphertext for computation, generates a preliminary result ciphertext by a homomorphic operation algorithm without decrypting the ciphertext for computation and a data ciphertext, and generates an inference result ciphertext by a homomorphic operation algorithm, using the preliminary result ciphertext and the ciphertext for inference that have not been decrypted. A partial decryption device (600) generates a partial decryption result by performing partial decryption on the inference result ciphertext, using a model secret key. A final decryption device (700) decrypts an inference result from the partial decryption result, using a data secret key.

### CROSS REFERENCE TO RELATED APPLICATION

This application is a Continuation of PCT International Application No. PCT/JP2020/048498, filed on Dec. 24, 2020, which is hereby expressly incorporated by reference into the present application.

### TECHNICAL FIELD

The present disclosure relates to confidential information processing.

### BACKGROUND ART

Homomorphic encryption is a cryptographic technology that allows operations to be performed on data while the data remains encrypted.

Recently, the use of cloud services is spreading, and it is conceivable that data is encrypted and then stored on a cloud due to concerns about cracking and the reliability of the cloud.

Homomorphic encryption allows operations to be performed on encrypted data without decryption.

Therefore, homomorphic encryption allows the use of cloud services without compromising security.

A neural network is a technology useful for image and video recognition, and is composed of three types of layers: an input layer, (multiple) intermediate layers, and an output layer.

The input layer is a layer for accepting input data.

The intermediate layers are layers for performing specific computation on input data or computation results of other intermediate layers.

The output layer is a layer for outputting a final computation result of the intermediate layers.

In recent years, neural networks that achieve high inference accuracy have been actively researched. Such a neural network has a great many intermediate layers, and its inference processing requires a huge amount of computation.

Therefore, it is difficult for a terminal with low computational capability to execute inference processing of such a neural network.

Thus, it is conceivable that inference processing is outsourced to a cloud with high computational capability.

When private data such as images of a surveillance camera is input data to a neural network, inference processing of the neural network needs to be performed while keeping the input data secret from the cloud.

In this case, by using homomorphic encryption to perform inference processing by the neural network while the input data remains encrypted, inference processing can be outsourced to the cloud while maintaining the privacy of a data provider.

However, if inference model data that defines computation of the intermediate layers of the neural network is not encrypted, parameter information of the inference model data and information on learning data used for learning to generate the inference model data may be leaked.

A service in which an input data provider performs inference processing on a cloud using inference model data of an inference model provider has the following requirements.

It is assumed that inference processing is outsourced to the cloud while the input data provider and the inference model provider both maintain the confidentiality of input data and inference model data. In this case, the input data needs to be encrypted with an encryption key of the input data provider, and the inference model data needs to be encrypted with an encryption key of the inference model provider.

Non-Patent Literature 1 discloses inference processing of a convolutional neural network while input data and inference model data both remain encrypted.

### CITATION LIST

### Non-Patent Literature

Non-Patent Literature 1: H. Chen, W. Dai, M. Kim, Y. Song. “Efficient Multi-key Homomorphic Encryption with Packed Ciphertexts with Application to Oblivious Neural Network Inference”. In ACM CCS, page 395-412, 2019.

### SUMMARY OF INVENTION

### Technical Problem

The method of Non-Patent Literature 1 utilizes a cryptographic technology called multi-key homomorphic encryption to realize inference processing while the input data remains encrypted with the encryption key of the input data provider and the inference model data remains encrypted with the encryption key of the inference model provider.

Multi-key homomorphic encryption is a type of homomorphic encryption scheme, and allows operations to be performed on ciphertexts encrypted with different encryption keys without decrypting the ciphertexts.

However, inference processing realized by the method of Non-Patent Literature 1 is inference processing of a convolutional neural network.

An object of the present disclosure is to make it possible to realize inference processing of a recurrent neural network while input data and inference model data both remain encrypted.

### Solution to Problem

A confidential information processing system of the present disclosure includes
a model division unit to divide a model ciphertext obtained by encrypting inference model data obtained by concatenating a first matrix and a second matrix into a ciphertext for inference and a ciphertext for computation, the ciphertext for inference being equivalent to a ciphertext of the first matrix, the ciphertext for computation being equivalent to a ciphertext of the second matrix;
a preliminary computation unit to generate a preliminary result ciphertext by a homomorphic operation algorithm without decrypting the ciphertext for computation and a data ciphertext obtained by encrypting input data, the preliminary result ciphertext being equivalent to a ciphertext of a product of the first matrix and a vector representing the input data;
a homomorphic inference unit to generate an inference result ciphertext by a homomorphic operation algorithm, using the preliminary result ciphertext and the ciphertext for inference that have not been decrypted, the inference result ciphertext being a ciphertext of an inference result for the input data;
a partial decryption unit to perform partial decryption on the inference result ciphertext to generate a partial decryption result, using a model secret key that is a secret key for the model ciphertext; and
a final decryption unit to decrypt the inference result for the input data from the partial decryption result, using a data secret key that is a secret key for the data ciphertext.

### Advantageous Effects of Invention

According to the present disclosure, it is possible to realize inference processing of a recurrent neural network while input data and inference model data both remain encrypted.

### BRIEF DESCRIPTION OF DRAWINGS

FIG. 1 is a configuration diagram of a confidential information processing system 100 in Embodiment 1;

FIG. 2 is a configuration diagram of a key generation device 200 in Embodiment 1;

FIG. 3 is a configuration diagram of a data encryption device 300 in Embodiment 1;

FIG. 4 is a configuration diagram of a model encryption device 400 in Embodiment 1;

FIG. 5 is a configuration diagram of a homomorphic inference device 500 in Embodiment 1;

FIG. 6 is a configuration diagram of a partial decryption device 600 in Embodiment 1;

FIG. 7 is a configuration diagram of a final decryption device 700 in Embodiment 1;

FIG. 8 is a flowchart illustrating a procedure for managing a data key pair in Embodiment 1;

FIG. 9 is a flowchart illustrating a procedure for managing a model key pair in Embodiment 1;

FIG. 10 is a flowchart illustrating a procedure for preliminary computation in Embodiment 1;

FIG. 11 is a flowchart illustrating a procedure for homomorphic inference in Embodiment 1;

FIG. 12 is a flowchart illustrating a procedure for decrypting an inference result ciphertext in Embodiment 1; and

FIG. 13 is a diagram for describing a hardware configuration of each device of the confidential information processing system 100 in Embodiment 1.

### DESCRIPTION OF EMBODIMENTS

In the embodiments and drawings, the same elements or corresponding elements are denoted by the same reference sign. Description of an element denoted by the same reference sign as that of an element that has been described will be suitably omitted or simplified. Arrows in diagrams mainly indicate flows of data or flows of processing.

### Embodiment 1

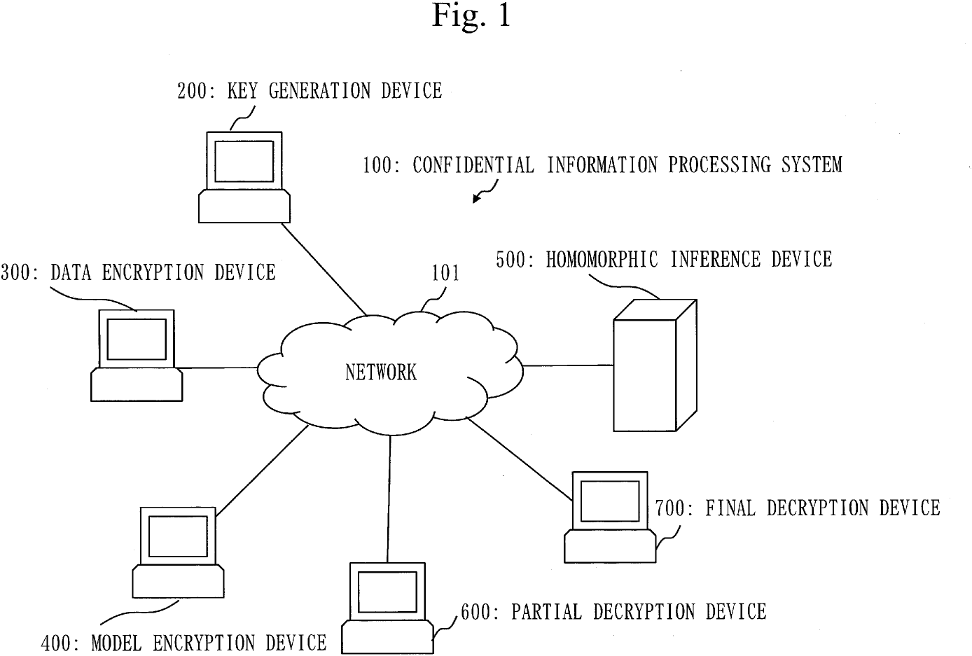

A confidential information processing system 100 will be described based on FIGS. 1 to 13.

### Description of Configuration

Based on FIG. 1, a configuration of the confidential information processing system 100 will be described.

The confidential information processing system 100 includes a key generation device 200, a data encryption device 300, a model encryption device 400, a homomorphic inference device 500, a partial decryption device 600, and a final decryption device 700. These devices are connected to a network 101 and communicate with one another via the network 101. A specific example of the network 101 is the Internet.

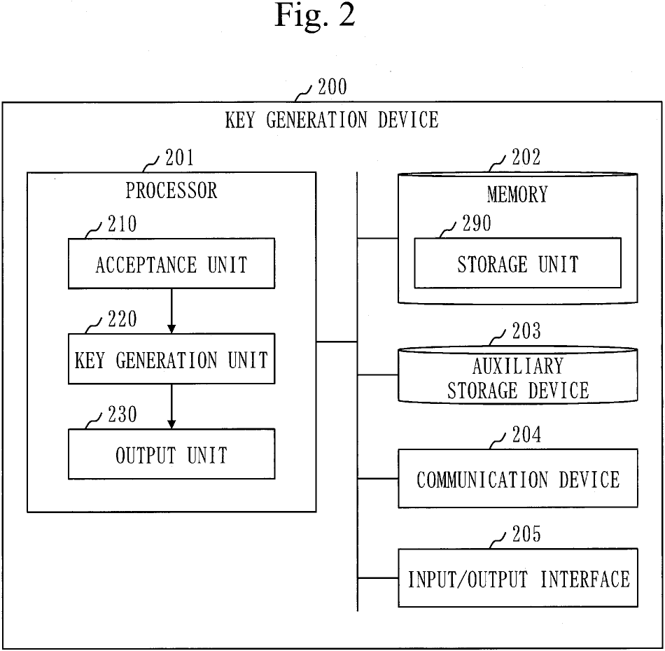

Based on FIG. 2, a configuration of the key generation device 200 will be described.

The key generation device 200 is a computer that includes hardware such as a processor 201, a memory 202, an auxiliary storage device 203, a communication device 204, and an input/output interface 205. These hardware components are connected with one another through signal lines.

The processor 201 is an IC that performs operational processing, and controls other hardware components. For example, the processor 201 is a CPU, a DSP, or a GPU.

IC is an abbreviation for integrated circuit.

CPU is an abbreviation for central processing unit.

DSP is an abbreviation for digital signal processor.

GPU is an abbreviation for graphics processing unit.

The memory 202 is a volatile or non-volatile storage device. The memory 202 is also called a main storage device or a main memory. For example, the memory 202 is a RAM. Data stored in the memory 202 is saved in the auxiliary storage device 203 as necessary.

RAM is an abbreviation for random access memory.

The auxiliary storage device 203 is a non-volatile storage device. For example, the auxiliary storage device 203 is a ROM, an HDD, or a flash memory. Data stored in the auxiliary storage device 203 is loaded into the memory 202 as necessary.

ROM is an abbreviation for read only memory.

HDD is an abbreviation for hard disk drive.

The communication device 204 is a receiver and a transmitter. For example, the communication device 204 is a communication chip or a NIC. Communication of the key generation device 200 is performed using the communication device 204.

NIC is an abbreviation for network interface card.

The input/output interface 205 is a port to which an input device and an output device are connected. For example, the input/output interface 205 is a USB terminal, the input device is a keyboard and a mouse, and the output device is a display. Input to and output from the key generation device 200 are performed using the input/output interface 205.

USB is an abbreviation for Universal Serial Bus.

The key generation device 200 includes elements such as an acceptance unit 210, a key generation unit 220, and an output unit 230. These elements are realized by software.

The auxiliary storage device 203 stores a key generation program to cause a computer to function as the acceptance unit 210, the key generation unit 220, and the output unit 230. The key generation program is loaded into the memory 202 and executed by the processor 201.

The auxiliary storage device 203 further stores an OS. At least part of the OS is loaded into the memory 202 and executed by the processor 201.

The processor 201 executes the key generation program while executing the OS.

OS is an abbreviation for operating system.

Input data and output data of the key generation program are stored in a storage unit 290.

The memory 202 functions as the storage unit 290. However, another storage device such as the auxiliary storage device 203, a register in the processor 201, and a cache memory in the processor 201 may function as the storage unit 290 in place of the memory 202 or together with the memory 202.

The key generation device 200 may include a plurality of processors as an alternative to the processor 201.

The key generation program can be recorded (stored) in a computer readable format in a non-volatile recording medium such as an optical disc or a flash memory.

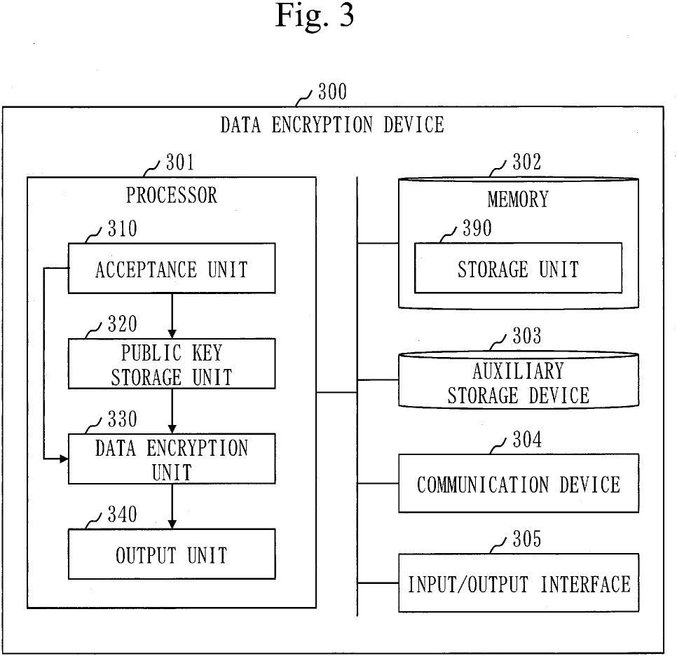

Based on FIG. 3, a configuration of the data encryption device 300 will be described.

The data encryption device 300 is a computer that includes hardware such as a processor 301, a memory 302, an auxiliary storage device 303, a communication device 304, and an input/output interface 305. These hardware components are connected with one another through signal lines. These hardware components correspond to the hardware components of the key generation device 200.

The data encryption device 300 includes elements such as an acceptance unit 310, a public key storage unit 320, a data encryption unit 330, and an output unit 340. These elements are realized by software.

The auxiliary storage device 303 stores a data encryption program to cause a computer to function as the acceptance unit 310, the public key storage unit 320, the data encryption unit 330, and the output unit 340. The data encryption program is loaded into the memory 302 and executed by the processor 301.

Input data and output data of the data encryption program are stored in a storage unit 390.

The memory 302 functions as the storage unit 390. However, another storage device of the data encryption device 300 may function as the storage unit 390 in place of the memory 302 or together with the memory 302.

The data encryption device 300 may include a plurality of processors as an alternative to the processor 301.

The data encryption program can be recorded (stored) in a computer readable format in a non-volatile recording medium.

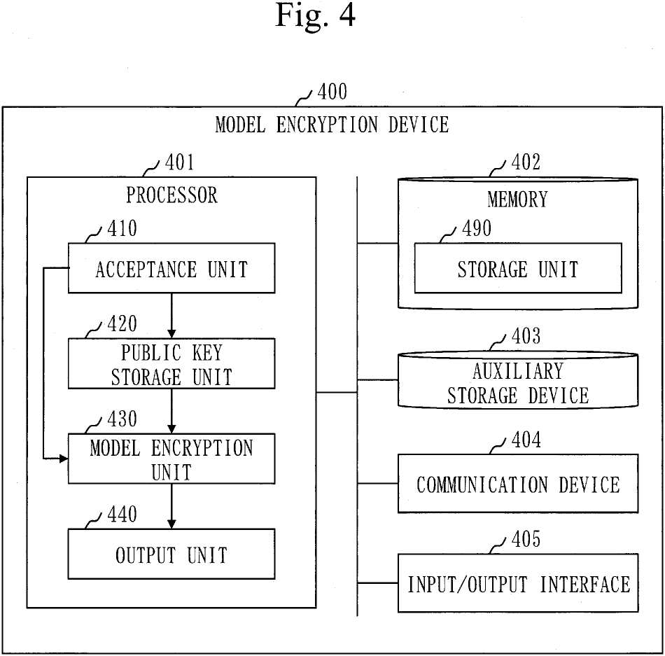

Based on FIG. 4, a configuration of the model encryption device 400 will be described.

The model encryption device 400 is a computer that includes hardware such as a processor 401, a memory 402, an auxiliary storage device 403, a communication device 404, and an input/output interface 405. These hardware components are connected with one another through signal lines. These hardware components correspond to the hardware components of the key generation device 200.

The model encryption device 400 includes elements such as an acceptance unit 410, a public key storage unit 420, a model encryption unit 430, and an output unit 440. These elements are realized by software.

The auxiliary storage device 403 stores a model encryption program to cause a computer to function as the acceptance unit 410, the public key storage unit 420, the model encryption unit 430, and the output unit 440. The model encryption program is loaded into the memory 402 and executed by the processor 401.

Input data and output data of the model encryption program are stored in a storage unit 490.

The memory 402 functions as the storage unit 490. However, another storage device of the model encryption device 400 may function as the storage unit 490 in place of the memory 402 or together with the memory 402.

The model encryption device 400 may include a plurality of processors as an alternative to the processor 401.

The model encryption program can be recorded (stored) in a computer readable format in a non-volatile recording medium.

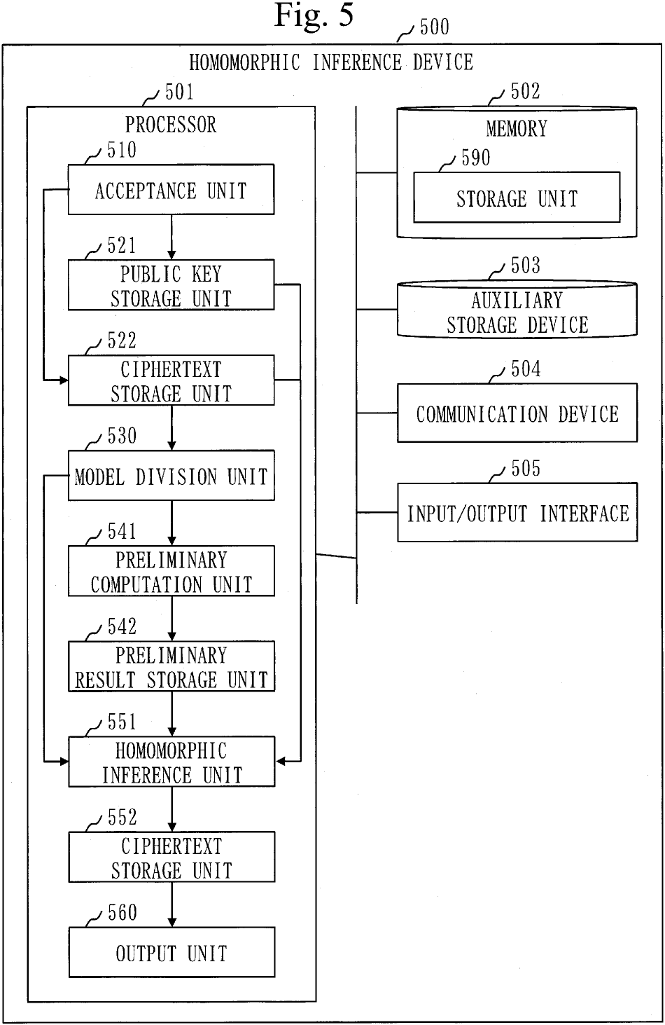

Based on FIG. 5, a configuration of the homomorphic inference device 500 will be described.

The homomorphic inference device 500 is a computer that includes hardware such as a processor 501, a memory 502, an auxiliary storage device 503, a communication device 504, and an input/output interface 505. These hardware components are connected with one another through signal lines. These hardware components correspond to the hardware components of the key generation device 200.

The homomorphic inference device 500 includes elements such as an acceptance unit 510, a public key storage unit 521, a ciphertext storage unit 522, a model division unit 530, a preliminary computation unit 541, a preliminary result storage unit 542, a homomorphic inference unit 551, a ciphertext storage unit 552, and an output unit 560. These elements are realized by software.

The auxiliary storage device 503 stores a homomorphic inference program to cause a computer to function as the acceptance unit 510, the public key storage unit 521, the ciphertext storage unit 522, the model division unit 530, the preliminary computation unit 541, the preliminary result storage unit 542, the homomorphic inference unit 551, the ciphertext storage unit 552, and the output unit 560. The homomorphic inference program is loaded into the memory 502 and executed by the processor 501.

Input data and output data of the homomorphic inference program are stored in a storage unit 590.

The memory 502 functions as the storage unit 590. However, another storage device of the homomorphic inference device 500 may function as the storage unit 590 in place of the memory 502 or together with the memory 502.

The homomorphic inference device 500 may include a plurality of processors as an alternative to the processor 501.

The homomorphic inference program can be recorded (stored) in a computer readable format in a non-volatile recording medium.

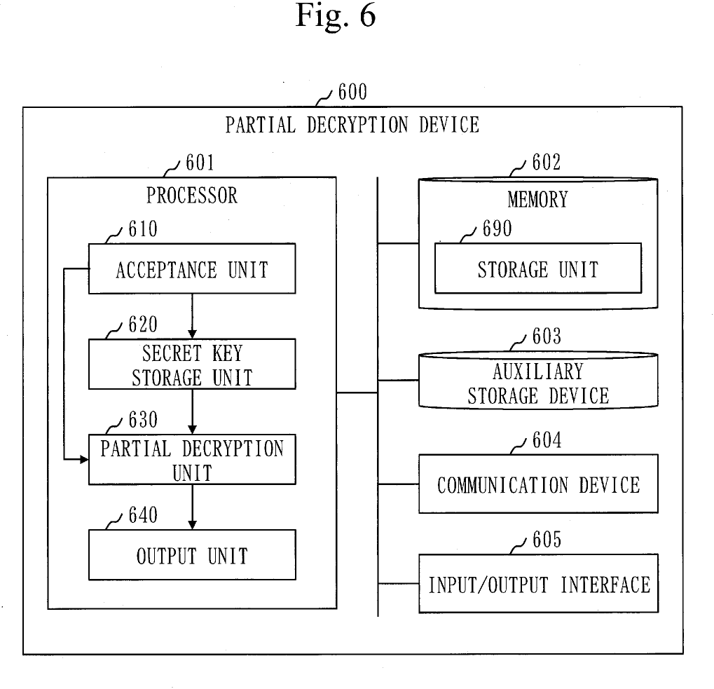

Based on FIG. 6, a configuration of the partial decryption device 600 will be described.

The partial decryption device 600 is a computer that includes hardware such as a processor 601, a memory 602, an auxiliary storage device 603, a communication device 604, and an input/output interface 605. These hardware components are connected with one another through signal lines. These hardware components correspond to the hardware components of the key generation device 200.

The partial decryption device 600 includes elements such as an acceptance unit 610, a secret key storage unit 620, a partial decryption unit 630, and an output unit 640. These elements are realized by software.

The auxiliary storage device 603 stores a partial decryption program to cause a computer to function as the acceptance unit 610, the secret key storage unit 620, the partial decryption unit 630, and the output unit 640. The partial decryption program is loaded into the memory 602 and executed by the processor 601.

Input data and output data of the partial decryption program are stored in a storage unit 690.

The memory 602 functions as the storage unit 690. However, another storage device of the partial decryption device 600 may function as the storage unit 690 in place of the memory 602 or together with the memory 602.

The partial decryption device 600 may include a plurality of processors as an alternative to the processor 601.

The partial decryption program can be recorded (stored) in a computer readable format in a non-volatile recording medium.

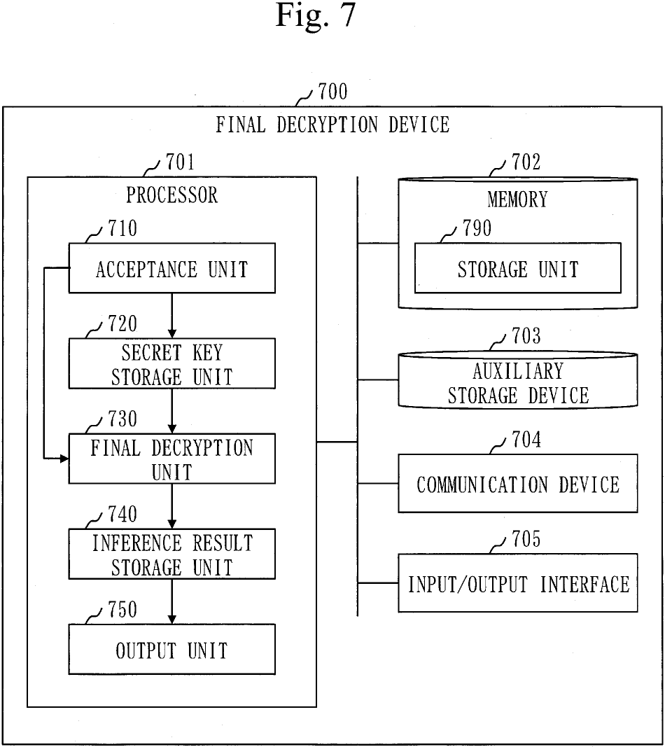

Based on FIG. 7, a configuration of the final decryption device 700 will be described.

The final decryption device 700 is a computer that includes hardware such as a processor 701, a memory 702, an auxiliary storage device 703, a communication device 704, and an input/output interface 705. These hardware components are connected with one another through signal lines. These hardware components correspond to the hardware components of the key generation device 200.

The final decryption device 700 includes elements such as an acceptance unit 710, a secret key storage unit 720, a final decryption unit 730, an inference result storage unit 740, and an output unit 750. These elements are realized by software.

The auxiliary storage device 703 stores a final decryption program to cause a computer to function as the acceptance unit 710, the secret key storage unit 720, the final decryption unit 730, the inference result storage unit 740, and the output unit 750. The final decryption program is loaded into the memory 702 and executed by the processor 701.

Input data and output data of the final decryption program are stored in a storage unit 790.

The memory 702 functions as the storage unit 790. However, another storage device of the final decryption device 700 may function as the storage unit 790 in place of the memory 702 or together with the memory 702.

The final decryption device 700 may include a plurality of processors as an alternative to the processor 701.

The final decryption program can be recorded (stored) in a computer readable format in a non-volatile recording medium.

### Description of Operation

A procedure for operation of the confidential information processing system 100 is equivalent to a confidential information processing method. The procedure for operation of the confidential information processing system 100 is also equivalent to a procedure for processing by a confidential information processing program.

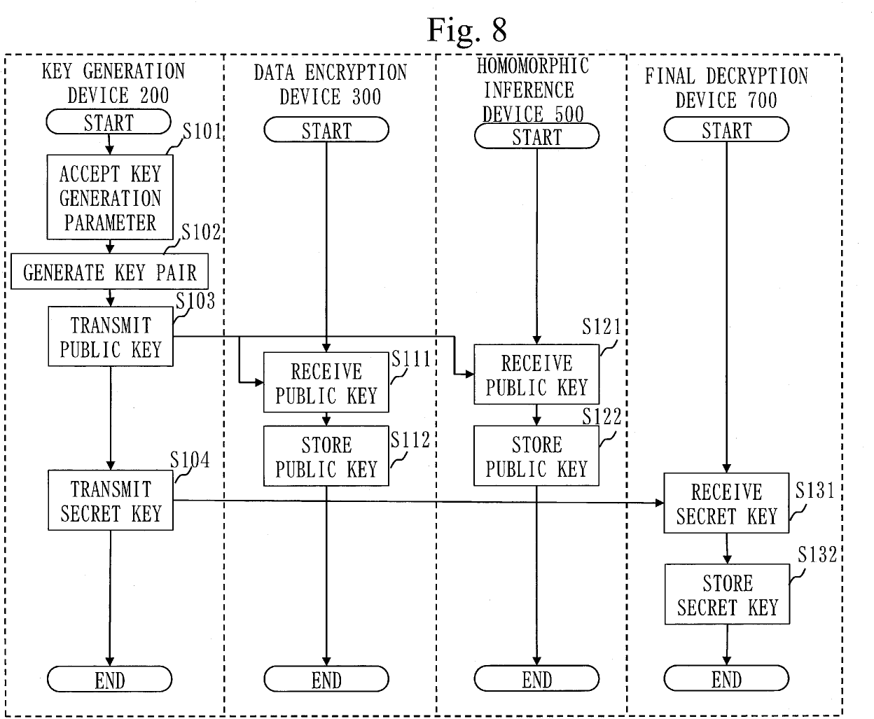

Based on FIG. 8, management of a data key pair will be described.

The data key pair is a key pair for input data dt to be described later, and is composed of a data public key and a data secret key.

The data public key is a public key for encrypting the input data dt.

The data secret key is a secret key corresponding to the data public key. A ciphertext of the input data dₜ can be decrypted with the data secret key. A ciphertext is data obtained by encryption.

Step S101 to step S104 are executed by the key generation device 200.

In step S101, the acceptance unit 210 accepts a parameter λ₁.

The parameter λ₁ is a key generation parameter for the data key pair. For example, the parameter λ₁ is input to the key generation device 200 by a user.

In step S102, the key generation unit 220 executes a key generation algorithm using as input the parameter λ₁. As a result, a public key PKi and a secret key SKi are generated.

The public key PKi is the data public key, and the secret key SKi is the data secret key.

For example, the key generation algorithm described in the following Literature (1) is used.

Literature (1): H. Chen, I. Chillotti, Y. Song. “Multi-key Homomorphic Encryption from TFHE”. In ASIACRYPT, pages 446-472, 2019.

In step S103, the output unit 230 transmits the public key PKi to each of the data encryption device 300 and the homomorphic inference device 500.

In step S104, the output unit 230 transmits the secret key SKi to the final decryption device 700.

Step S111 and step S112 are executed by the data encryption device 300.

In step S111, the acceptance unit 310 receives the public key PKi.

In step S112, the public key storage unit 320 stores the public key PKi in the storage unit 290.

Step S121 and step S122 are executed by the homomorphic inference device 500.

In step S121, the acceptance unit 510 receives the public key PKi.

In step S122, the public key storage unit 521 stores the public key PKi in the storage unit 590.

Step S131 and step S132 are executed by the final decryption device 700.

In step S131, the acceptance unit 710 receives the secret key SKi.

In step S132, the secret key storage unit 720 stores the secret key SKi in the storage unit 790. The secret key SKi is stored securely so as not to be leaked to the outside.

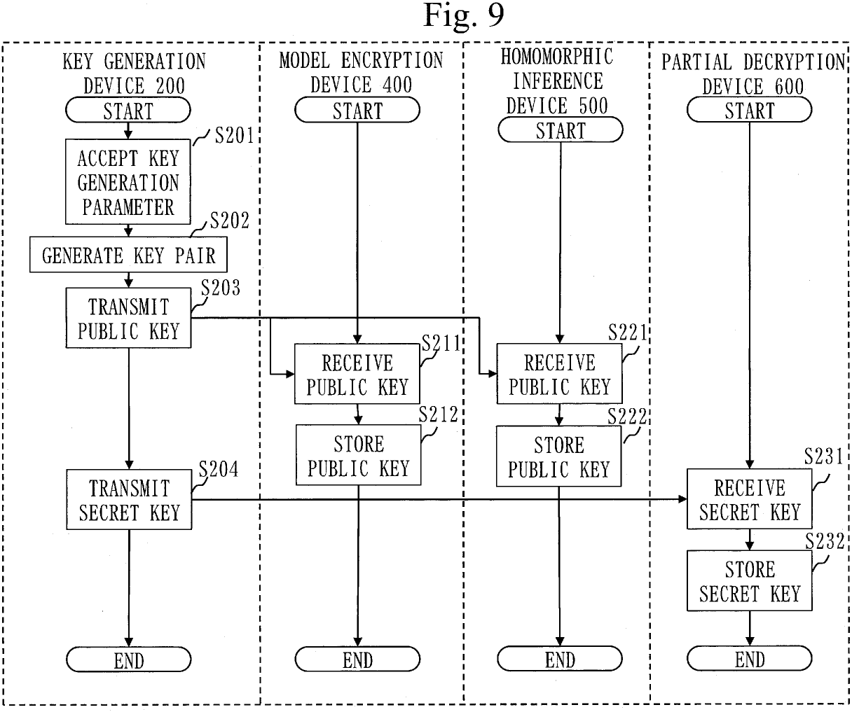

Based on FIG. 9, management of a model key pair will be described.

The model key pair is a key pair for inference model data M to be described later, and is composed of a model public key and a model secret key.

The model public key is a public key for encrypting the inference model data M.

The model secret key is a secret key corresponding to the model public key. A ciphertext of the inference model data M can be decrypted with the model secret key.

Step S201 to step S204 are executed by the key generation device 200.

In step S201, the acceptance unit 210 accepts a parameter λ₂.

The parameter λ₂ is a key generation parameter for the model key pair. For example, the parameter λ₂ is input to the key generation device 200 by a user.

In step S202, the key generation unit 220 executes the key generation algorithm using as input the parameter λ₂. As a result, a public key PK₂ and a secret key SK₂ are generated.

The public key PK₂ is the model public key, and the secret key SK₂ is the model secret key.

For example, the key generation algorithm described in the above Literature (1) is used.

In step S203, the output unit 230 transmits the public key PK₂ to each of the model encryption device 400 and the homomorphic inference device 500.

In step S204, the output unit 230 transmits the secret key SK₂ to the partial decryption device 600.

Step S211 and step S212 are executed by the model encryption device 400.

In step S211, the acceptance unit 410 receives the public key PK₂.

In step S212, the public key storage unit 420 stores the public key PK₂ in the storage unit 490.

Step S221 and step S222 are executed by the homomorphic inference device 500.

In step S221, the acceptance unit 510 receives the public key PK₂.

In step S222, the public key storage unit 521 stores the public key PK₂ in the storage unit 590.

Step S231 and step S232 are executed by the partial decryption device 600.

In step S231, the acceptance unit 610 receives the secret key SK₂.

In step S232, the secret key storage unit 620 stores the secret key SK₂ in the storage unit 690. The secret key SK₂ is stored securely so as not to be leaked to the outside.

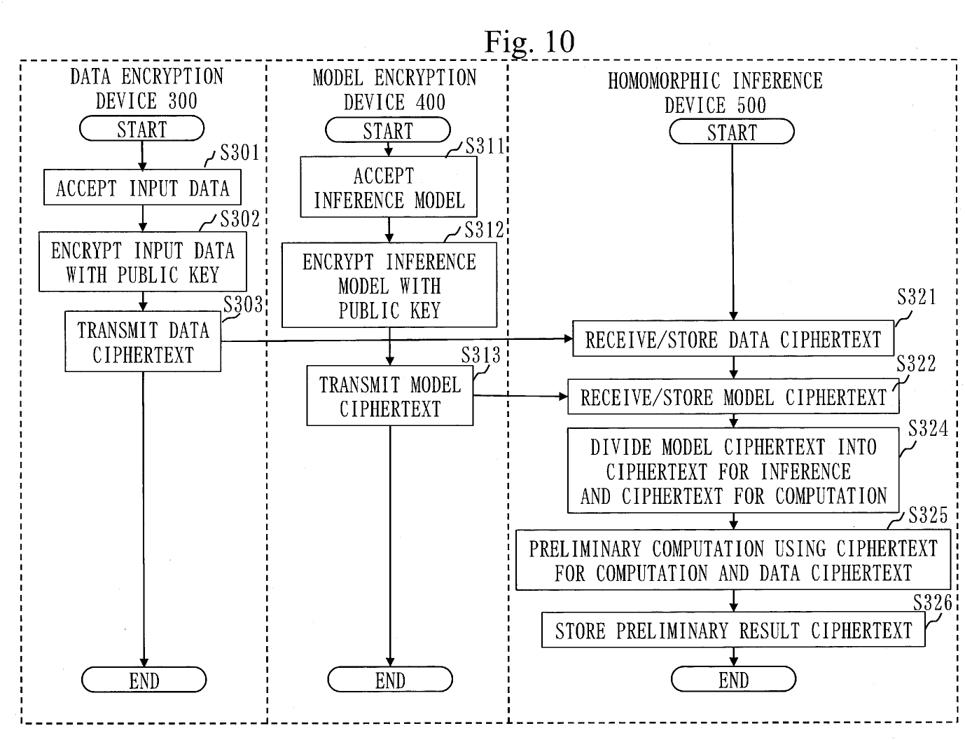

Based on FIG. 10, preliminary computation for obtaining a ciphertext of an inference result will be described.

Step S301 to step S303 are executed by the data encryption device 300.

In step S301, the acceptance unit 310 accepts the input data dt.

The input data dₜ is input data at time t. “t” is an integer (natural number) equal to or greater than 1.

Input data is represented by a vector composed of n floating-point numbers. “n” is an integer equal to or greater than 1.

For example, the acceptance unit 310 collects, from various sensors installed in a factory, measurement values (floating-point numbers) obtained at time t by the various sensors. The collected measurement values are used as the input data dₜ.

In step S302, the data encryption unit 330 encrypts the input data dt. Specifically, the data encryption unit 330 executes an encryption algorithm on the input data dt, using the public key PKi. As a result, a data ciphertext C(dt) is generated.

The data ciphertext C(dt) is the input data dt that has been encrypted, that is, a ciphertext of the input data dₜ.

For example, each element of the input data dt is encrypted by the encryption algorithm described in the above Literature (1).

In step S303, the output unit 340 transmits the data ciphertext C(dt) to the homomorphic inference device 500.

Step S311 to step S313 are executed by the model encryption device 400.

In step S311, the acceptance unit 410 accepts the inference model data M. For example, the inference model data M is input to the model encryption device 400 by a user. However, the inference model data M may be stored in the storage unit 490 in advance.

In step S312, the model encryption unit 430 encrypts the inference model data M. Specifically, the model encryption unit 430 executes the encryption algorithm on the inference model data M, using the public key PK₂. As a result, a model ciphertext C(M) is generated.

The model ciphertext C(M) is the inference model data M that has been encrypted, that is, a ciphertext of the inference model data M.

For example, the encryption algorithm described in the above Literature (1) is used.

The inference model data M will be described.

The inference model data M is data for an inference model (M). The inference model (M) is a machine learning model for inference processing, and is represented by a recurrent neural network. A specific recurrent neural network is “LSTM”.

LSTM is an abbreviation for long short-term memory.

The inference model data M is a matrix with k × (n + m) elements. Each of the elements is a floating-point number.

“k” is an integer equal to or greater than 1.

“n” is an integer equal to or greater than 1 (as described above).

“m” is an integer equal to or greater than 1.

For the inference model data M, M = [M′ || M″] holds.

“M′” is a matrix with k × n elements. Each of the elements is a floating-point number.

“M″” is a matrix with k × m elements. Each of the elements is a floating-point number.

[M′ || M″] means a matrix obtained by concatenating the matrix M′ and the matrix M″.

Inference processing using the inference model data M is represented by Expression (1). [Formula 1]

$$\text{M} ⋅ \left[\begin{matrix}{\text{D}}_{t - 1} \\ {\text{d}}_{t}\end{matrix}\right] = {\text{M}}^{′} ⋅ {\text{D}}_{t - 1} + {\text{M}}^{″} ⋅ {\text{d}}_{t} \qquad \text{(Expression 1)}$$

“Dₜ₋₁” is an inference result at time t-1, and is represented by a vector composed of n floating-point numbers.

“dt” is input data at time t, and is represented by a vector composed of n floating-point numbers.

“•” denotes a multiplication of a matrix and a vector.

“+” denotes an addition of vectors.

The description will be continued from step S313.

In step S313, the output unit 440 transmits the model ciphertext C(M) to the homomorphic inference device 500.

Step S321 to step S326 are executed by the homomorphic inference device 500. In step S321, the acceptance unit 510 receives the data ciphertext C(dt).

Then, the ciphertext storage unit 522 stores the data ciphertext C(dt) in the storage unit 590.

In step S322, the acceptance unit 510 receives the model ciphertext C(M).

Then, the ciphertext storage unit 522 stores the model ciphertext C(M) in the storage unit 590.

In the following, the model ciphertext will be denoted as “C(M)” or “W”.

The model ciphertext W can be represented by Expression (2). [Formula 2]

$$\text{W} = \left[{\text{W}}^{′} \text{\textbar \textbar} {\text{W}}^{″}\right] \qquad \text{(Expression 2)}$$

“W′” denotes a ciphertext for inference. The ciphertext for inference W′ is equivalent to the matrix M′ that has been encrypted by the encryption algorithm used to encrypt the inference model data M, that is, a ciphertext of the matrix M′. That is, the ciphertext for inference W′ is a matrix with k × n encrypted elements.

“W″” denotes a ciphertext for computation. The ciphertext for computation W″ is equivalent to the matrix M″ that has been encrypted by the encryption algorithm used to encrypt the inference model data M, that is, a ciphertext of the matrix M″. That is, the ciphertext for computation W″ is a matrix with k × m encrypted elements.

In step S324, the model division unit 530 divides the model ciphertext W into the ciphertext for inference W′ and the ciphertext for computation W″.

In step S325, the preliminary computation unit 541 executes preliminary computation using the data ciphertext C(dt) and the ciphertext for computation W″.

Specifically, the preliminary computation unit 541 generates a preliminary result ciphertext C(Dt″) without decrypting the ciphertext for computation W″ and the data ciphertext C(dt).

The preliminary result ciphertext C(Dt″) is equivalent to a ciphertext obtained by encrypting the product of the matrix M″ and the vector representing the input data dₜ.

The preliminary result ciphertext C(Dt″) is calculated by a homomorphic operation algorithm.

The homomorphic operation algorithm is an algorithm of homomorphic encryption (in particular, multi-key homomorphic encryption).

For example, the homomorphic operation algorithm described in the above Literature (1) is used.

In step S326, the preliminary result storage unit 542 stores the preliminary result ciphertext C(Dt″) in the storage unit 590.

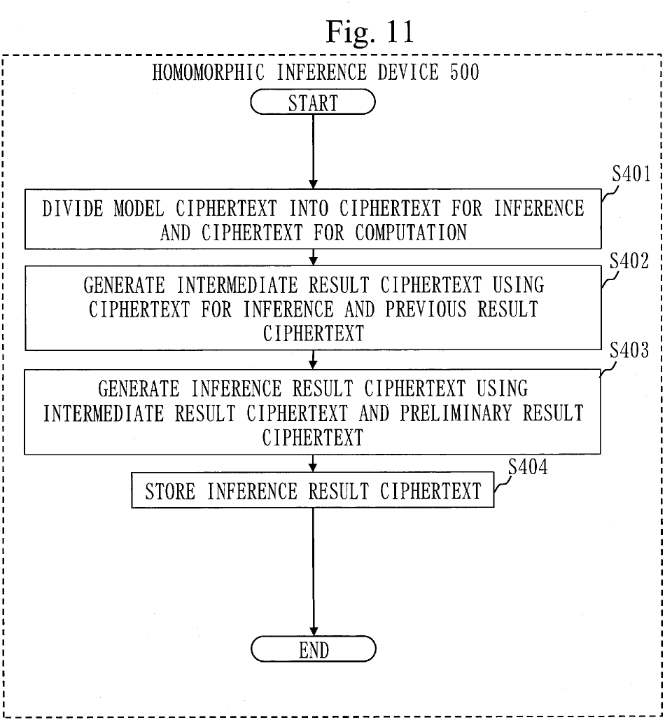

Based on FIG. 11, homomorphic inference will be described.

Step S401 to step S403 are executed by the homomorphic inference device 500.

In step S401, the model division unit 530 divides the model ciphertext W into the ciphertext for inference W′ and the ciphertext for computation W″.

In step S402, the homomorphic inference unit 551 executes intermediate inference processing using a previous result ciphertext C(Dt-i) and the ciphertext for inference W′.

The previous result ciphertext C(Dt-i) is an encrypted inference result for input data dt-i of the previous time, that is, a ciphertext of an inference result of the previous time.

Specifically, the homomorphic inference unit 551 generates an intermediate result ciphertext C(Dt-i′) using the previous result ciphertext C(Dt-i) and the ciphertext for inference W′ without decrypting them.

The intermediate result ciphertext C(Dt-i′) is equivalent to a ciphertext obtained by encrypting the product of the matrix M′ and the vector representing the inference result for the input data dt-i of the previous time.

The intermediate result ciphertext C(Dt-i′) is calculated by the homomorphic operation algorithm.

For example, the homomorphic operation algorithm described in the above Literature (1) is used.

In step S403, the homomorphic inference unit 551 executes final inference processing using the intermediate result ciphertext C(Dt-i′) and the preliminary result ciphertext C(Dt″).

Specifically, the homomorphic inference unit 551 generates an inference result ciphertext C(Dt) using the intermediate result ciphertext C(Dt-i′) and the preliminary result ciphertext C(Dt″) without decrypting them.

The inference result ciphertext C(Dt) is an encrypted inference result for the input data dt of the current time, that is, a ciphertext of an inference result of the current time.

The inference result ciphertext C(Dt) is equivalent to a ciphertext obtained by encrypting a result of adding the vector obtained by decrypting the intermediate result ciphertext C(Dt-i′) and the vector obtained by decrypting the preliminary result ciphertext C(Dt″).

The inference result ciphertext C(Dₜ) is calculated by the homomorphic operation algorithm.

For example, the homomorphic operation algorithm described in the above Literature (1) is used.

In step S404, the ciphertext storage unit 552 stores the inference result ciphertext C(Dt) in the storage unit 590.

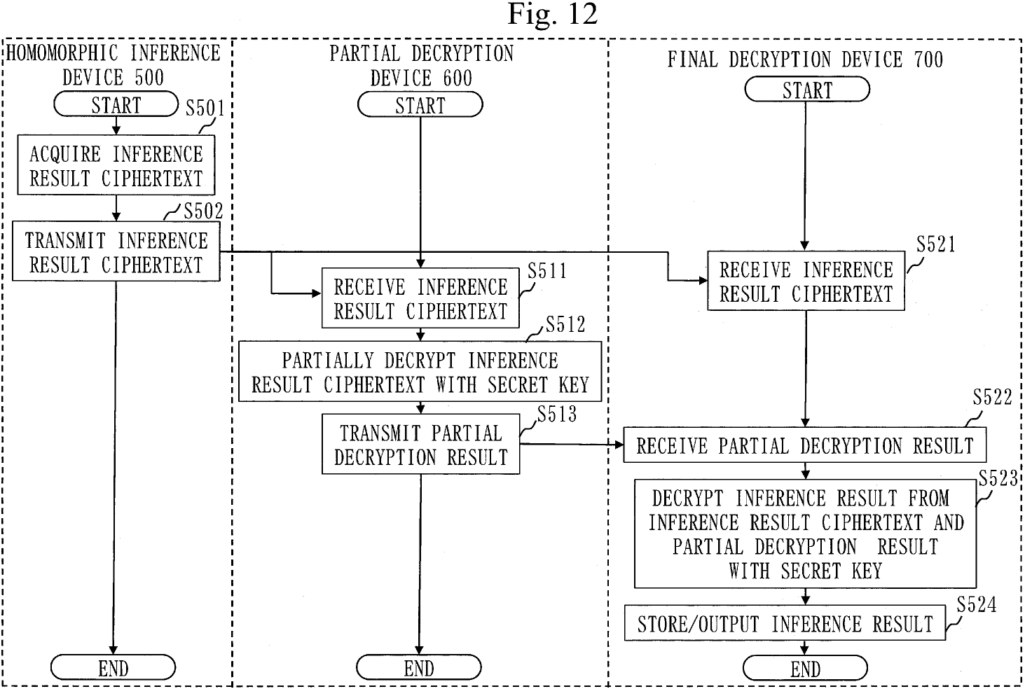

Based on FIG. 12, decryption of the inference result ciphertext C(Dt) will be described.

Step S501 and step S502 are executed by the homomorphic inference device 500.

In step S501, the output unit 560 acquires the inference result ciphertext C(Dt) from the storage unit 590.

In step S502, the output unit 560 transmits the inference result ciphertext C(Dt) to each of the partial decryption device 600 and the final decryption device 700.

Step S511 to step S513 are executed by the partial decryption device 600.

In step S511, the acceptance unit 610 receives the inference result ciphertext C(Dt).

In step S512, the partial decryption unit 630 performs partial decryption on the inference result ciphertext C(Dt), using the secret key SK₂. As a result, a partial decryption result C(D_{2,t}) is generated.

Specifically, the partial decryption unit 630 calculates each element d′_{2,t} of the partial decryption result C(D_{2,t}) by computing Expression (3).

That is, the partial decryption unit 630 calculates the inner product of the vector that is an element of the inference result ciphertext C(Dt) and the vector representing the secret key SK₂, and calculates a result of adding the calculated inner product and a value selected from a probability distribution. The calculated result is each element d′_{2,t} of the partial decryption result C(D_{2,t}). [Formula 3]

$$\begin{matrix}e ← χ , \\ {{d}^{′}}_{2 , t} = \left〈c , {\text{SK}}_{2}\right〉 + e\end{matrix} \qquad \text{(Expression 3)}$$

“c” denotes a vector constituting one element of the inference result ciphertext C(Dt). The inference result ciphertext C(Dt) is a vector or a matrix. For example, the vector or matrix representing the inference result ciphertext C(Dt) has, as elements, ciphertexts of the encryption scheme described in the above Literature (1).

“X” denotes a specific probability distribution. For example, the probability distribution X is a discrete normal distribution with values 0, ½³², ..., (2³² - 1)/2³².

“e” denotes a value selected according to the probability distribution X.

<c, SK₂> denotes the inner product of the vector C and the vector representing the secret key SK₂.

In step S513, the output unit 640 transmits the partial decryption result C(D_{2,t}) to the final decryption device 700.

Step S521 to step S524 are executed by the final decryption device 700.

In step S521, the acceptance unit 710 receives the inference result ciphertext C(Dt).

In step S522, the acceptance unit 710 receives the partial decryption result C(D2,t).

In step S523, the final decryption unit 730 decrypts inference result data Dt from the inference result ciphertext C(Dt) and the partial decryption result C(D_{2,t}), using the secret key SKi.

Specifically, the final decryption unit 730 calculates each element d’t of the inference result data Dt by computing Expression (4).

That is, the final decryption unit 730 calculates the inner product of the vector that is an element of the inference result ciphertext C(Dt) and the vector representing the secret key SKi, calculates the sum obtained by adding the calculated inner product and an element of the partial decryption result C(D_{2,t}), and determines each element d’t of the inference result data Dt based on the calculated sum. [Formula 4]

$$\begin{matrix}{{d}^{′}}_{1 , t} = \left〈c , {\text{SK}}_{1}\right〉 \\ {{d}^{′}}_{t} = {\left[{{d}^{′}}_{1 , t} + {{d}^{′}}_{2 , t}\right]}_{1 / 4}\end{matrix} \qquad \text{(Expression 4)}$$

<c, SKi> denotes the inner product of the vector C and the vector representing the secret key SKi.

[A] _{¼} represents 1 if a value A is close to ¼, and represents 0 if the value A is not close to ¼. Specifically, [A] _{¼} represents 1 if the difference between the value A and ¼ is smaller than a threshold value, and represents 0 if the difference between the value A and ¼ is greater than the threshold value. [A] _{¼} represents 1 or 0 if the difference between the value A and ¼ is equal to the threshold value.

In step S524, the inference result storage unit 740 stores the inference result data Dt in the storage unit 790.

The output unit 750 outputs the inference result data Dt. For example, the output unit 750 displays the inference result data Dt on a display.

### Effects of Embodiment 1

The confidential information processing system 100 can execute inference processing by a recurrent neural network while input data remains encrypted. Therefore, the confidential information processing system 100 allows inference processing to be outsourced to a cloud while protecting the privacy of a data provider.

The confidential information processing system 100 can execute inference processing by a recurrent neural network while inference model data remains encrypted. Therefore, the confidential information processing system 100 allows inference processing to be outsourced to a cloud while protecting the privacy of a model provider.

Before executing inference processing of time t in a recurrent neural network, the confidential information processing system 100 can execute processing not dependent on inference result data of time t-1 in the inference processing of time t (preliminary processing).

In order to execute inference processing while input data and inference model data remain encrypted, ciphertext expansion processing needs to be performed due to the characteristics of multi-key homomorphic encryption. Multi-key homomorphic encryption is the homomorphic encryption scheme described in the above Literature (1). Ciphertext expansion processing is, for example, processing to convert a ciphertext that can be decrypted with the secret key SKi to a ciphertext that can be decrypted by using both the secret key SKi and the secret key SK₂.

By executing ciphertext expansion processing as preliminary computation processing, the computational overhead due to ciphertext expansion processing and the like can be reduced in the actual inference processing. That is, it is possible to efficiently realize inference processing of a recurrent neural network while input data and inference model data remain encrypted.

### Supplement to Embodiment 1

Two or more devices of the devices included in the confidential information processing system 100 may be combined into one device. For example, the data encryption device 300 and the model encryption device 400 may be combined into one device, or the partial decryption device 600 and the final decryption device 700 may be combined into one device.

Transmission and reception of data between devices may be replaced by postal mailing of data or input and output of data by a user.

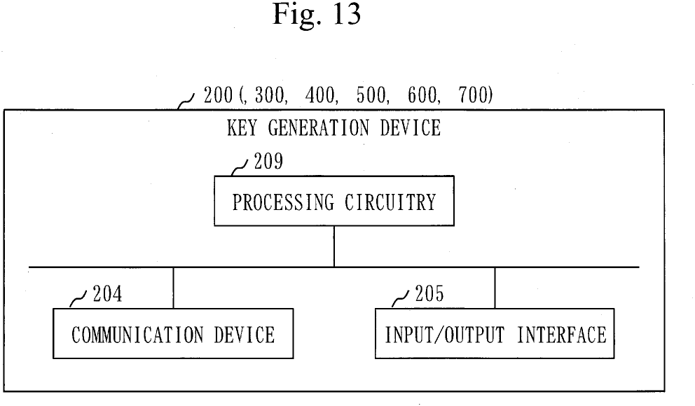

Based on FIG. 13, a hardware configuration of the key generation device 200 will be described.

The key generation device 200 includes processing circuitry 209.

The processing circuitry 209 is hardware that realizes the elements of the key generation device 200.

The processing circuitry 209 may be dedicated hardware, or may be the processor 201 that executes programs stored in the memory 202.

When the processing circuitry 209 is dedicated hardware, the processing circuitry 209 is, for example, a single circuit, a composite circuit, a programmed processor, a parallel-programmed processor, an ASIC, an FPGA, or a combination of these.

ASIC is an abbreviation for application specific integrated circuit.

FPGA is an abbreviation for field programmable gate array.

The key generation device 200 may include a plurality of processing circuits as an alternative to the processing circuitry 209.

In the processing circuitry 209, some functions may be realized by dedicated hardware, and the remaining functions may be realized by software or firmware.

As described above, the functions of the key generation device 200 can be realized by hardware, software, firmware, or a combination of these.

The hardware configuration of each of the data encryption device 300, the model encryption device 400, the homomorphic inference device 500, the partial decryption device 600, and the final decryption device 700 is substantially the same as the hardware configuration of the key generation device 200.

Embodiment 1 is an example of a preferred embodiment and is not intended to limit the technical scope of the present disclosure. Embodiment 1 may be implemented partially, or may be implemented in combination with another embodiment. The procedures described using the flowcharts or the like may be suitably modified.

Each “unit” that is an element of each device of the confidential information processing system 100 may be interpreted as “process”, “step”, “circuit”, or “circuitry”.

### Reference Signs List

100: confidential information processing system, 101: network, 200: key generation device, 201: processor, 202: memory, 203: auxiliary storage device, 204: communication device, 205: input/output interface, 209: processing circuitry, 210: acceptance unit, 220: key generation unit, 230: output unit, 290: storage unit, 300: data encryption device, 301: processor, 302: memory, 303: auxiliary storage device, 304: communication device, 305: input/output interface, 310: acceptance unit, 320: public key storage unit, 330: data encryption unit, 340: output unit, 390: storage unit, 400: model encryption device, 401: processor, 402: memory, 403: auxiliary storage device, 404: communication device, 405: input/output interface, 410: acceptance unit, 420: public key storage unit, 430: model encryption unit, 440: output unit, 490: storage unit, 500: homomorphic inference device, 501: processor, 502: memory, 503: auxiliary storage device, 504: communication device, 505: input/output interface, 510: acceptance unit, 521: public key storage unit, 522: ciphertext storage unit, 530: model division unit, 541: preliminary computation unit, 542: preliminary result storage unit, 551: homomorphic inference unit, 552: ciphertext storage unit, 560: output unit, 590: storage unit, 600: partial decryption device, 601: processor, 602: memory, 603: auxiliary storage device, 604: communication device, 605: input/output interface, 610: acceptance unit, 620: secret key storage unit, 630: partial decryption unit, 640: output unit, 690: storage unit, 700: final decryption device, 701: processor, 702: memory, 703: auxiliary storage device, 704: communication device, 705: input/output interface, 710: acceptance unit, 720: secret key storage unit, 730: final decryption unit, 740: inference result storage unit, 750: output unit, 790: storage unit.

1. A confidential information processing system comprising
processing circuitry to perform:
a model division process of dividing a model ciphertext obtained by encrypting inference model data obtained by concatenating a first matrix and a second matrix into a ciphertext for inference and a ciphertext for computation, the ciphertext for inference being equivalent to a ciphertext of the first matrix, the ciphertext for computation being equivalent to a ciphertext of the second matrix;
a preliminary computation process of generating a preliminary result ciphertext by a homomorphic operation algorithm without decrypting the ciphertext for computation and a data ciphertext obtained by encrypting input data, the preliminary result ciphertext being equivalent to a ciphertext of a product of the first matrix and a vector representing the input data;
a homomorphic inference process of generating an inference result ciphertext by a homomorphic operation algorithm, using the preliminary result ciphertext and the ciphertext for inference that have not been decrypted, the inference result ciphertext being a ciphertext of an inference result for the input data;
a partial decryption process of performing partial decryption on the inference result ciphertext to generate a partial decryption result, using a model secret key that is a secret key for the model ciphertext; and
a final decryption process of decrypting the inference result for the input data from the partial decryption result, using a data secret key that is a secret key for the data ciphertext.

2. The confidential information processing system according to claim 1,
wherein the homomorphic inference process generates the inference result ciphertext using the preliminary result ciphertext, the ciphertext for inference, and a previous result ciphertext that have not been decrypted, the previous result ciphertext being a ciphertext of an inference result for input data of a previous time.

3. The confidential information processing system according to claim 2,
wherein the homomorphic inference process generates an intermediate result ciphertext by a homomorphic operation algorithm, using the ciphertext for inference and the previous result ciphertext that have not been decrypted, the intermediate result ciphertext being equivalent to a ciphertext of a product of the first matrix and a vector representing the inference result for the input data of the previous time, and
generates, as the inference result ciphertext, a ciphertext of a result of adding a vector obtained by decrypting the intermediate result ciphertext and a vector obtained by decrypting the preliminary result ciphertext by a homomorphic operation algorithm, using the intermediate result ciphertext and the preliminary result ciphertext that have not been decrypted.

4. The confidential information processing system according to claim 1,
wherein the partial decryption process calculates, as an element of the partial decryption result, a result of adding a value selected from a probability distribution and an inner product of a vector that is an element of the inference result ciphertext and a vector representing the model secret key.

5. The confidential information processing system according to claim 1,
wherein the final decryption process decrypts the inference result for the input data from the inference result ciphertext and the partial decryption result, using the data secret key.

6. The confidential information processing system according to claim 5,
wherein the final decryption process determines an element of the inference result based on a sum obtained by adding an element of the partial decryption result and an inner product of a vector that is an element of the inference result ciphertext and a vector representing the data secret key.

7. The confidential information processing system according to claim 6,
wherein the final decryption process determines the element of the inference result based on a difference between the sum and ¼.

8. The confidential information processing system according to claim 7,
wherein the final decryption process determines the element of the inference result as 1 when the difference is smaller than a threshold value, and determines the element of the inference result as 0 when the difference is greater than the threshold value.

9. The confidential information processing system according to claim 1, further comprising:
a homomorphic inference device that includes processing circuitry to perform the model division process, the preliminary computation process, and the homomorphic inference process;
a partial decryption device that includes processing circuitry to perform the partial decryption process; and
a final decryption device that includes processing circuitry to perform the final decryption process.

10. The confidential information processing system according to claim 1,
wherein the processing circuitry performs a data encryption process of encrypting the input data to generate the data ciphertext, using a data public key that is a public key for the input data, and
a model encryption process of encrypting the inference model data to generate the model ciphertext, using a model public key that is a public key for the inference model data.

11. The confidential information processing system according to claim 10, further comprising:
a data encryption device that includes processing circuitry to perform the data encryption process; and
a model encryption device that includes processing circuitry to perform the model encryption process.

12. The confidential information processing system according to claim 10,
wherein the processing circuitry performs a key generation process of generating a pair of the data public key and the data secret key and a pair of the model public key and the model secret key.

13. The confidential information processing system according to claim 12, further comprising
a key generation device that includes processing circuitry to perform the key generation process.

14. A confidential information processing method comprising:
dividing a model ciphertext obtained by encrypting inference model data obtained by concatenating a first matrix and a second matrix into a ciphertext for inference and a ciphertext for computation, the ciphertext for inference being equivalent to a ciphertext of the first matrix, the ciphertext for computation being equivalent to a ciphertext of the second matrix;
generating a preliminary result ciphertext by a homomorphic operation algorithm without decrypting the ciphertext for computation and a data ciphertext obtained by encrypting input data, the preliminary result ciphertext being equivalent to a ciphertext of a product of the first matrix and a vector representing the input data;
generating an inference result ciphertext by a homomorphic operation algorithm, using the preliminary result ciphertext, the ciphertext for inference, and a previous result ciphertext that have not been decrypted, the inference result ciphertext being a ciphertext of an inference result for the input data, the previous result ciphertext being a ciphertext of an inference result for input data of a previous time;
performing partial decryption on the inference result ciphertext to generate a partial decryption result, using a model secret key that is a secret key for the model ciphertext; and
decrypting the inference result for the input data from the partial decryption result, using a data secret key that is a secret key for the data ciphertext.
